(19) United States
(12) Patent Application Publication
(10) Pub. No.: US 2014/0280727 A1
(43) Pub. Date: Sep. 18, 2014

(54) VENUE-SPECIFIC AMUSEMENT DEVICE NETWORK

(71) Applicant: AMI Entertainment Network, LLC, Trevose, PA (US)

(72) Inventors: Ronald RICHARDS, Elmhurst, IL (US); Michael G. MAAS, New Hope, PA (US); Stephen JAREMA, III, Pittsgrove, NJ (US); Augustus John RUSSO, Blue Bell, PA (US); William L. LAYNE, IV, Harleysville, PA (US); Robert Michael MARTIN, Holland, PA (US); Brennan MC TERNAN, Fanwood, NJ (US); Jeffrey J. KALIS, Sparta, MI (US)

(73) Assignee: AMI Entertainment Network, LLC, Trevose, PA (US)

(21) Appl. No.: 14/212,742

(22) Filed: Mar. 14, 2014

Related U.S. Application Data
(60) Provisional application No. 61/784,252, filed on Mar. 14, 2013.

(51) Int. Cl. H04L 29/08

(52) U.S. Cl. CPC H04L 67/10
USPC 709/217

(57) ABSTRACT

A venue-specific entertainment system is described. A communications controller is configured to communicate with electronic devices deployed at a venue, including at least two different types of electronic devices. The electronic devices are configured to communicate with one another by transmitting messages through the communications controller. The communications controller detects events based upon information from the electronic devices and transmits messages to other electronic devices to modify their output based upon the detected events.

### CROSS-REFERENCE TO RELATED APPLICATION

This application claims the benefit of U.S. Provisional Application No. 61/784,252, filed Mar. 14, 2013.

### FIELD OF THE INVENTION

Embodiments of the present invention relate generally to venue-specific amusement device networks. More particularly, embodiments of the present invention are directed to methods and systems for communicating between different types of amusement devices deployed at a single venue.

### BACKGROUND OF THE INVENTION

Various electronic devices may be found at entertainment venues such as bars, restaurants, airports, shopping malls, video arcades, casinos, or the like. Such electronic devices include, for instance, digital and analog televisions, projectors, computer displays, portable computing devices, tablet computing devices, digital jukeboxes, and currency-operated amusement devices. The electronic devices typically are configured to output a plurality of content choices, such as electronic games, animations, videos, and audio files. The game choices may include card games, sports games, games of skill, games of chance, action games, trivia games, or the like.

Each of the electronic devices may be utilized by the venue to provide programming or content to patrons of the venue. However, such electronic devices are typically incapable of communicating with one another. Thus, each electronic device, or groups of electronic devices, must be separately controlled in order to synchronize operation. This synchronization requires a significant effort on the part of venue staff and management.

Accordingly, it is desirable to allow electronic devices deployed at a venue to communicate with one another. It is further desirable to attract patrons' attention to the electronic devices and to increase patrons' enjoyment of and interactivity with the electronic devices at the venue by providing a uniform experience at the venue. It is further desirable to encourage venue owners and operators to purchase compatible equipment to add functionality to the venue, and to replace incompatible competitor's equipment and upgrade legacy equipment.

### BRIEF SUMMARY OF THE INVENTION

A venue-specific entertainment system is described. A communications controller is configured to communicate with electronic devices deployed at a venue, including at least two different types of electronic devices. The electronic devices are configured to communicate with one another by transmitting messages through the communications controller. The communications controller detects events based upon information from the electronic devices and transmits messages to other electronic devices to modify their output based upon the detected events.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a venue-specific entertainment system according to one embodiment of the invention;

FIG. 2 is a sequence diagram of a performance of an event-based activity according to a preferred embodiment of the invention; and

FIG. 3 is a sequence diagram of a performance of an event-based activity according to another embodiment of the invention.

### DETAILED DESCRIPTION OF THE INVENTION

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, FIG. 1 includes a plurality of electronic devices 105 deployed at a venue, such as a bar, casino, restaurant, or the like. The electronic devices 105 allow the venue operator to provide entertainment to venue patrons and to increase profitability of the venue through patrons' interactions with the electronic devices 105. As shown in FIG. 1, at least a subset of the electronic devices 105 deployed at a venue 100 are networked with, or communicatively coupled to, a location manager Among other functions, location manager 170 serves as a communications controller for the devices connected through a network 10.

The network 10 may be a Local Area Network (LAN) or Wide Area Network (WAN), such as the Internet. The electronic devices 105 may be connected to the network 10 by one or more network cables, or wirelessly by, for example, by a network interface such as an IEEE 802.11 Wi-Fi adapter.

Electronic devices 105 include, but are not limited to currency-operated jukeboxes 130, currency-operated amusement devices 120, mobile devices 160 (e.g., smartphones, tablet devices), televisions 140, and the like. All of the electronic devices 105 deployed at a venue are preferably co-registered to the venue in a location database, or the like which stores location information for electronic devices 105 deployed at all venues associated with the location manager 170. It is to be understood that “television,” as used herein, may refer to a television or a television system comprising a combination of television and associated set-top box, such as a cable box, video disc player, or computer system for providing video input to the television.

Co-registration of the electronic devices 105 allows for a more uniform experience to be presented across all of the electronic devices 105 deployed at a single venue through synchronization by a location manager 170. In a preferred embodiment, a venue operator or owner manually registers electronic devices 105 with the venue in the location database. In an alternative embodiment, electronic devices 105 automatically register their location with the location database based on, for example, wireless network information, IP address information, geographic information, or the like. In a preferred embodiment, the location manager 170 is at a remote, centralized, geographic location, such as in a data center. However, in other embodiments, a local venue controller (not shown) may perform some or all of the duties of the location manager 170 without departing from the scope of this invention. If necessary, the local venue controller may be in communication with the location manager 170 over the network 10 as are the electronic devices 105. Furthermore, in certain embodiments, the electronic devices 105 may be communicatively coupled to the location manager 170 through the venue controller.

The location manager 170 includes one or more servers, controllers, databases and/or other computing devices, that, at least in part, control presentation of content by the electronic devices 105. In one embodiment, location manager 170 comprises one or more venue information servers 170A, jukebox servers 170B, game servers 170C, and other servers 170D.

In one embodiment, the location manager 170 provides a unified interface for configuring, and communicating with, each of the electronic devices 105 deployed at a venue. The unified interface of the location manager 170 is preferably accessible locally through a touchscreen or point and click interface, such as via the operations office computer 110 accessing a website or application associated with the location manager 170, allowing venue staff and/or management to quickly and easily control the presentation of electronic devices 105 deployed at the venue. For example, the unified interface of the location manager 170 may be used to organize the electronic devices 105 into one or more subgroups to perform particular functions or activities desired by venue staff.

Servers of the location manager 170 store and transmit content such as music, games, videos, photos, and software updates to the electronic devices 105 through the network 10. The location manager 170 optionally also interconnects electronic devices 105 deployed at multiple venues to allow for interaction between patrons at distinct venue location. The location manager 170 further includes, or is coupled to, one or more storage devices, such as hard disk drives, flash drives, optical drives, or the like. The mass storage device(s) store software, such as an operating system, for controlling the operation of location manager 170.

A graphical user interface (not shown) is provided by the location manager 170, allowing venue staff to create and distribute venue-specific content to the electronic devices 105. For example, the venue may wish to introduce a special offer for one or more food menu items. Once the special offer is created by the venue staff, for example, using the office computer 110, the location manager 170 transmits the special offer for display on one or more of the electronic devices 105 deployed at the venue. Such special offers may be created on-demand, or they may be pre-stored and scheduled to be displayed at predetermined times. Thus, if a venue is known to have a special offer on a food item every Thursday between the hours of 6 pm and 9 pm, the location manager 170 can be programmed to display the special offer on the electronic devices 105 deployed at the venue each week during this time. In one embodiment, only the televisions 140 at the venue display such venue-generated content. However, preferably, other electronic devices 105 (e.g., electronic jukeboxes 130 and currency-operated amusement devices 120) may also display the same content.

Other advertisements and promotions may be created and managed through the location manager 170. These advertisements and promotions may be specific to an individual electronic device 105, specific to a group of electronic devices 105, or global to all electronic devices 105 deployed at a venue, or at multiple venues. Such advertisements and promotions may include graphics, video, and/or audio, or any combination thereof. Promotions may include, for example, free credits, games, songs, or the like, and may be awarded through the location manager 170. Preferably, a daily, weekly, or monthly limit on the amount of such promotions is configured on an account-based and a location-based basis. Such promotions may be sent to specific electronic devices 105 or to multiple electronic devices 105. Reports relating to usage, promotions, patrons, and the like may be viewed based on acquired and compiled interaction data.

The location manager 170 preferably manages a location profile, in the form of a database entry or the like, for each participating venue 100A, 100B. The location profile includes general location details such as name, address and business type, as well as information about electronic devices 105 deployed at the venue. Additional location information such as leagues, tournaments and upcoming entertainment events are included in the location profile. In addition, location data may be collected by the location manager 170 from social networks and shopping sites such as FACEBOOK, TWITTER, YELP, GROUPON, FOURSQUARE, and the like.

The location manager 170 is preferably configured to manage broadcast notifications and messages sent to, by, and between the electronic devices 105 deployed at the location. Therefore, the location manager 170 preferably manages actions, interactions, and activities between all of the electronic devices 105 deployed at a venue. Interactions are preferably one or more actions taken by one or more electronic devices 105 deployed at a venue in response to one or more actions taken by another one or more electronic devices 105 deployed at the same or another venue. Such interactions with each of the electronic devices 105 will now be described in further detail.

In interacting with jukeboxes 130, the location manager 170 may control promotions such as providing free song plays and/or credits to a particular jukebox 130 or a user's account. Similarly, special announcements, such as birthday messages, party groups, or the like, may be issued from the location manager 170 to be output by the jukebox 130. These messages may be transmitted in response to requests from users at other electronic devices 105. Settings changes, such as music catalog controls, management controls of a jukebox 130, such as refunds, song rejections, pausing and switching jukebox 130 audio output to television 140 audio, may be made by the location manager 170. Venue events may be facilitated by the location manager 170, including functions such as listening parties, karaoke mode, background music mode, or the like, to be performed by the jukebox 130. Location-based song control allows for the location manager 170 to provide location-based soundboards that include school fight songs, sports songs, and the like, to be played by the jukebox 130.

Similarly, inter-device events allow for the jukebox 130 to perform particular actions in response to events occurring on one or more other electronic devices 105. For example, the location manager 170 may cause the jukebox 130 to perform an action, such as playing a school's fight song or muting or unmuting audio output, in response to a television 140 displaying a start or stop of a sporting event, a commercial break, or in-game scoring plays. Furthermore, an output queue of the jukebox 130 may be managed by and/or from the location manager 170. Available management options include, but are not limited to, viewing the queue and the requesting users, adding songs to the queue, removing songs from queue, moving songs up or down in the queue, and the like. Finally, the location manager 170 allows viewing of user statistics, such as when a user last logged into the jukebox 130, how often a particular user logs in, how much money has been spent by a user, and favorite songs and playlists of a user or multiple users.

The location manager 170 interacts with currency-operated amusement devices 120 by applying promotions (e.g., free game credits), changing settings (e.g., volume, light show), and managing events (e.g., setting up tournaments, leagues, etc.). The location manager 170 may view reports of all pending, running, or completed events participated in by users using the venue's amusement devices 120. Reports may also be provided for user information and statistics for a single or multiple amusement devices 120 at a venue. Such information includes data about when and how often a user logs into a particular amusement device 120, how much money the player has spent at the amusement device 120, or other electronic devices 105 deployed at the venue, and events at the venue that the player has participated in. Other types of information that may be available is known to those skilled in the art.

The location manager 170 interacts with mobile applications executed on a mobile device 160 of users currently or previously checked in at the venue. The interactions include providing promotions, such as exclusive offers to patrons (e.g., loyalty offers, on premise coupons, raffles, or the like). Preferably, different promotions are sent to mobile devices 160 of currently checked-in patrons than to mobile devices 160 of previously checked-in patrons that are not currently checked-into the venue. Reports regarding checked-in patrons may be compiled by the location manager 170 to provide information relating to the location. For example, location-based league and tournament information may be collected for the venue.

In addition, general information about the patrons may be aggregated and stored by the location manager 170. Such information includes preferences of the patrons such as food, beverage, music, game, and video preferences. History and current status of individual checked-in patrons may also be aggregated by interacting with the mobile devices 160 of patrons. The aggregated data may be combined with data received by the location manager 170 from other venues. In one embodiment, personal user data may be anonymized prior to being transmitted to the location manager 170.

The location manager 170 interacts with televisions 140 by changing settings such as channel, volume, and power. Venue event management may be facilitated by setting up and managing television-based games (e.g., cards and trivia). Reports and/or information about pending, running, or completed events, games, contests, tournaments, or the like, occurring at the venue may be output to the televisions 140 for display to venue patrons. Additionally, when televisions 140 are presenting content, the location manager 170 may schedule content to be presented at particular points in the content, such as during timeouts, advertisement breaks and scoring plays of a sporting event. For example, during a timeout of a college sports contest, the location manager 170 may schedule a school's fight song to be played by a jukebox 130 until the timeout ends.

Referring to FIGS. 2 and 3, the electronic devices 105 have the ability to affect the output of other electronic devices 105 deployed at a single venue or at another venue by transmitting activity information through the location manager 170. As shown in FIG. 2, at 210, first electronic device 105A performs one or more functions. At 215, device 105A transmits data regarding the performed functions to the location manager 170. Similarly, at 220, device 105B performs its functions, and may also transmit data to location manager 170 as needed.

At 230, the location manager 170 receives this information and stores it in a storage device, such as a database (not shown) or the like. At 235, the stored data is analyzed. At 240, one or more events affecting the operation of one or more other amusement devices 105B at the venue of the first amusement device 105A are identified. Events for each of the amusement devices 105 will be discussed in further detail below.

At 245, once an event is identified, the location manager 170 identifies one or more actions that should be performed by the one or more other amusement devices 105B based on the identified event. At 250, the location manager 170 transmits one or more messages to the other amusement devices 105B. At 255, device 105B modifies its output in accordance with the message received from location manager 170.

In yet other embodiments, as shown in FIG. 3, the activities of one or more amusement devices 105C may be affected by activities performed by a plurality of amusement devices 105A and 105B. In this example, entertainment devices 105A and 105B perform activities at 310 and 320, respectively, and transmit data about performed activities to the location manager 170 at 315 and 325, respectively.

At 330, the location manager 170 stores the received data, and optionally aggregates it with data received from other amusement devices 105. At 335, the location manager 170 analyzes the data received from the devices. At 340, the location manager 170 identifies events associated with the received data. At 345, the location manager 170 identifies actions to be taken by the devices 105C based upon the received data and/or identified events. In one preferred embodiment, the events and actions to perform are identified by an expert knowledgebase system, or the like. At 350, one or more messages are transmitted to one or more devices 105C regarding the actions to be performed. At 355, the devices 105C modify their output in response to the messages received from location manager 170.

In other embodiments, electronic devices 105 may communicate directly or indirectly with other electronic devices 105 by transmitting messages or broadcasts through a venue controller (not shown). Broadcasts from an electronic device 105 deployed at a venue are preferably received by a subset or all of the other electronic devices 105 deployed at the venue of the transmitting electronic device 105. In the case of a broadcast message, each receiving electronic device 105 processes the received broadcast message and determines whether an action needs to be taken based on the content of the message, thereby ensuring an optimized user experience is provided by the electronic devices 105 deployed at the venue. In another embodiment, the location manager 170 determines which electronic devices 105 a message applies to, and filters the broadcast message to only the affected devices.

Different types of devices preferably detect and transmit data regarding both general events and events specific to the particular type of device. Events at each of the different types of electronic devices 105 will now be described in further detail.

A jukebox 130 allows media such as music, songs, and music videos to be selected and played automatically, or manually, by users and venue staff. Media to be played by the jukebox 130 may be selected from songs stored in a memory of the jukebox 130 or at the location manager 170, as well as by users accessing song listings using other electronic devices 105, such as a mobile application installed on a mobile device 160.

Users may enable transmitting information about actions performed by or on the jukebox 130 to other electronic devices 105. Thus, for example, when a user selects a song to be played on a jukebox 130, the song information may be displayed by one or more televisions 140 deployed at the venue. Similarly, song lyrics, dedications, and likes and dislikes may also be displayed, aggregated or analyzed by other electronic devices 105 through the location manager 170. Other messages include promotion of features available from the jukebox 130, information regarding a song that is currently playing, karaoke song information and lyrics, identification of and information about new songs and/or songs being promoted at the venue, and identification of a user making a song purchase on the jukebox 130.

Dedications of songs currently being played on a jukebox 130 may be broadcast to other electronic devices 105. Such dedications may include a text message, photo, video, audio, or other multimedia content. The dedications may be presented on any of the electronic devices 105 at the venue, but preferably are presented by mobile devices 160 and/or televisions 140. Thus, for example, the location manager 170 may cause a dedication message to be displayed on a television 140 simultaneously with the dedicated song being played by the jukebox 130. In other embodiments, audio dedications may be output to the venue's sound system by the jukebox 130 prior to the song being played. Audio dedications may be recorded by the requesting user using, for example, their mobile device 160, or automatically synthesized by text-to-speech circuitry and/or software of one or more of the electronic devices 105. In some embodiments, dedications may be transmitted from electronic devices 105 at a first venue to one or more electronic devices 105 deployed at one or more other venues.

Amusement devices 120 allow users to play one or more electronic games, videos or songs in response to a user inputting a sufficient number of credits. Amusement devices 120 include portable amusement devices, tabletop amusement devices, surface-mounted amusement devices, and the like.

Currency-operated amusement devices 120 can interact with other electronic devices 105 through the location manager 170. The currency-operated amusement devices 120 interact with the jukeboxes 130 by allowing users to search a catalog of media playable by the jukebox 130; access a user's playlists and favorites from a player account stored by the location manager 170; manage media playlists; view artist, song, and album details; select songs to play using credits; view songs currently playing on the jukebox; and access playlists of others (e.g., top 40 playlist).

The amusement devices 120 may also interact with other amusement devices 120 to allow users to play multiplayer games with other user at the same or a different venue over a network. A user at a first currency-operated amusement device 120 may challenge a user at another currency-operated amusement device 120 to start a multiplayer game. Users can accept challenges sent from other currency-operated amusement devices 120. In addition, in certain cases, users at one currency-operated amusement device 120 have the option to pay for game play at another currency-operated amusement device 120. The location manager 170 facilitates such multiplayer games by acting as a game server for all participating amusement devices 120.

Currency-operated amusement devices 120 include a wide range of message broadcast functionality for interacting with other electronic devices 105 deployed at the venue through the location manager 170. For example, available features of the currency-operated amusement device 120 may be promoted by displaying information on the other electronic devices 105, preferably the televisions 140. Such information can include information about newly added games, promoted games, current multiplayer game sessions at the venue, tournament information, and the like. In addition, live game play at one or more currency-operated amusement devices may be displayed as live game play video, or as score or results information on one or more electronic devices 105. Broadcasting the live game play to televisions 140 deployed at the venue allows other patrons to observe games as they are being played. Such displaying on televisions 140 may be especially preferable during tournament play at the venue.

Users seeking a partner or opponent to play multiplayer games may broadcast invitations to join a game on one or more of the electronic devices 105. For example, the invitations may be broadcast to other currency-operated amusement devices 120, televisions 140 and/or mobile devices 160 that are currently at the venue. The broadcast invitation may include additional information about the type of opponent the user is seeking (e.g., game identifier, game length, skill level, and the like). Some functions, such as interactive game play, may be provided to remote users using computers 150 or mobile devices 160.

Accomplishments achieved by users on the amusement devices 120, such as high scores, battle wins, and challenges earned may be broadcast to other electronic devices 105 for display, aggregation, or analysis. This information is preferably transmitted through the location manager 170, which determines what electronic devices 105 should receive the broadcast. Similarly, accomplishments may be retrieved from individual player accounts stored on the location manager 170 for display on the electronic devices 105 deployed at the venue. Event information for the venue, such as tournaments, contests, standings, and rankings may similarly be broadcast from the amusement devices 120 through the location manager 170 to other electronic devices 105 deployed at the venue.

Televisions 140 are capable of receiving and displaying information received from the location manager 170. For example, the location manager 170 may cause the televisions 140 to display trivia and facts about currently playing songs on a jukebox 130. Polling/voting information received from electronic devices 105 such as the mobile devices 160 is also displayed by televisions 140. Such polling/voting information includes results of contests, “likes” and “dislikes” received from venue patrons, and the like. In addition, televisions 140 may display a “game channel” that presents microgames and on-demand multiplayer games that venue patrons interact with using their mobile devices, as further described in U.S. Provisional Patent Application No. 61/616,233, which is incorporated by reference herein in its entirety, and is attached hereto as Appendix A. Televisions 140 also display information about winners of game channel games, single player and multiplayer games on amusement devices 120.

Users may also interact with the electronic devices 105 through the location manager 170 using a mobile application or web application interface executed on a mobile device 160, such as a smartphone or tablet device, or other computing device 150. The mobile device 160 may interact with jukeboxes 130, allowing users to search music, view album details, view artist details, read QR codes, get location information, store favorite song information, confirm song playback, play songs, view currently playing song information (artist information, artist factoids, song lyrics, selecting user information, etc.), vote on songs currently being played, find similar songs, or view song lyrics in karaoke format for sing along.

In some cases, the user of a mobile device 160 may be a venue staff member. Venue staff members may be provided with additional functions via mobile device 160 that would not be appropriate to provide to individual patrons. For instance, venue staff members may be provided with the ability to control the content to be displayed on a television 140, adjust the volume of a jukebox 130, set the filter in use on a jukebox 130, skip songs playing on jukebox 130, or perform other functions. Venue staff may also be provided with the ability to use mobile device 160 to modify system settings such as information regarding the venue (e.g., name or address).

The mobile device 160 may interact with currency-operated amusement devices 120 by sending money for credits to the currency-operated amusement device 120 being used by the user or other users. The mobile application on mobile device 160 also allows users to invite competitors or partners for multiplayer games, dance partners, and the like.

The mobile device 160 may also interact with other mobile devices 160 of other venue patrons by, for example, sending invitations to play a game; text, video, or audio messages; song requests; and favorite song information.

Similarly, the mobile application may interact with content or applications displayed on televisions 140 by functioning as a remote input device to provide responses to microgames and initiate and interact with on-demand multiplayer games, presented on a game channel of the televisions 140.

Other interactions with electronic devices 105 include shout-outs about songs during play, social network interaction (e.g., check-in or posts on FACEBOOK, TWITTER, FOURSQUARE, GOOGLE+, and the like). In additional embodiments, auto check-in functionality across multiple social networking services is provided.

The electronic devices 105 communicate with one another through the location manager 170 by transmitting notification messages. To facilitate these messages, the location manager 170 preferably includes a cluster of physical and/or virtual nodes that are connected on a network, such as a LAN. The cluster of nodes implement a protocol having an associated Applied Programming Interface (“API”). Preferably, the protocol includes multiple levels of security, utilizing at least the Secure Sockets Layer (SSL) protocol and a scrambler encryption algorithm.

Preferably, where there are multiple nodes in the cluster, each client (e.g., electronic devices 105) connects to only one of the nodes. The nodes share information with each other to keep track of which electronic devices 105 (i.e., clients) are connected to which nodes. New client connections are preferably allocated to nodes using a load balancing mechanism to ensure that the individual nodes do not become overloaded. If a node goes down, the clients 105 connected to it will automatically attempt to reconnect and will be assigned to a node in the location manager 170 that is still running.

While user authentication is not required for connection to the location manager 170, preferably the protocol limits access to only electronic devices 105 executing authorized applications. Authorized applications are preferably applications developed by a single developer, or by developers authorized to develop applications for use with the electronic devices 105 and/or the location manager 170. Authorized applications may be recognized using, for example, a handshake protocol, a certificate, a signature, or the like.

Preferably, each electronic device 105 is assigned a unique thirty-two (32) bit client identifier when it connects to a node in the location manager 170. The client identifier may be used for addressing, and may be a MAC address. Clients 105 may also optionally register a client name with the node of the location manager 170. This client name is preferably unique on the network, and may be for example, a device name or a MAC address. When available, the client names are mapped to the client identifiers in the nodes. Client names are useful to more easily identify the electronic devices 105 in the network 10. Electronic devices 105 preferably register using their device identifiers, allowing them to receive unsolicited messages using their respective device identifiers. For example, when the location manager 170 needs to queue a song to play on a jukebox 130 that was requested by a mobile device 160, the location manager 170 may determine the correct jukebox 130 based on its device identifier. Alternatively, a name resolution service may be provided. The name resolution service allows clients 105 to determine the device ID corresponding to a given client name. When a client uses a provided API to send a message to a particular client name, the API performs the name resolution in order to deliver the message to the proper client 105.

The protocol's API allows several functionalities to be performed. A Connect method establishes a network connection with the location manager 170. A Disconnect method terminates the connection to the location manager 170. In this case, if there are still clients 105 registered on the connection, they will automatically be deregistered. A Register method is used to establish an electronic device 105 as an endpoint on the location manager 170 network.

Once registered, a client endpoint can send and receive messages. When an electronic device 105 is registered it will supply a callback object that will be notified when new messages arrive or when errors arrive. A Deregister method removes a previously registered client endpoint. A Send method is used to send messages to other clients. The Send method is associated with a specific client endpoint and the API will ensure that the message's source address is correct. Variants of the Send method will allow for messages to be addressed to specific client IDs or to client names. A Receive method allows messages to be received asynchronously. Preferably, clients will not block waiting for messages. The Error method is an application provided callback method that is invoked when an error occurs (e.g. a message could not be delivered). The Error callback will receive an error code and the message that failed so that it can determine the proper course of action.

Messages are transmitted between clients 105 and the nodes of the location manager 170 over a TCP connection. Optionally, the messages are encrypted using SSL. In one embodiment, a message consists of a fixed length header, followed by a variable length data segment. The length of the data segment is preferably stored in the header for use in message framing. The routing components preferably do not look at the data segment of a message, except for copying it between queues for delivery, unless the message is addressed to the router itself.

Preferably, the message header consists of the fields shown in Table A:

TABLE A

| Field | Length (bits) |
|---|---|
| VERSION | 8 |
| FLAGS | 8 |
| ERROR | 8 |
| SCRAMBLER_INDEX | 8 |
| SOURCE | 32 |
| DESTINATION | 32 |
| LENGTH | 32 |

In Table A, the VERSION field indicates the protocol version number. The FLAGS field contains message flags. The value this field indicates special details related to the message. The ERROR field will contain an error code if an error flag is set. The SCRAMBLER_INDEX field is non-zero when the message body has been encrypted. The field indicates the scrambler index that was used to encrypt the message. The SOURCE field identifies the message sender. The DESTINATION field identifies the message recipient's client ID. A value of “0” indicates the message is directed at the routing layer itself (e.g. to establish a new client connection). The LENGTH field is the number of bytes in the message data, not counting the message header.

The process for joining the messenger network of the location manager 170 will now be described. First, a network connection to a node in the location manager 170 on a given hostname and port is opened. When the node in the location manager 170 accepts a new incoming connection, it generates a message to the new client 105 that contains a scrambled, or otherwise encrypted, challenge string. The challenge string is preferably a random sequence of characters. The client 105 decrypts the message and sends the challenge string back to the server scrambled, or otherwise encrypted. The node of the location manager 170 decrypts the message and compares it with the challenge it sent. If the strings match, the node assumes that the client 105 is an authenticated application and proceeds with client initialization. If the two strings do not match, the node will terminate the connection.

After sending the challenge response back to the node, the connection is considered established, but there are no clients 105 registered on it. A client 105 calls the Register API method in order to register itself. The caller has the option of specifying a client name and registration type, such as normal, broadcast group, or balanced group. The API will send a message to the protocol with the DESTINATION and SOURCE fields set to “0” and the body containing the registration information. If the client 105 is registering a client name and the requested name is already in use, the protocol will send a message to the client 105 with the error flag set and an error code in the ERROR field. In this case the client 105 is not registered and must either try again with a different name or abort.

If the client name is valid, or if no name was registered, the protocol will respond with a message telling the client 105 its client ID. At this point the client 105 is connected to the messenger network, and may send and receive messages. Each registered client 105 is a messaging end point. Thus, messages can originate or be delivered to registered clients 105. A connection may have multiple registered clients 105 and each client 105 has a separate message channel. The API further provides a way for applications to send and receive messages by each registered client 105.

In general a client 105 does not care about, or need to know, its client ID. The API will ensure that all messages sent by a client 105 have the correct client ID in the header field. There is no means for a client 105 to override this value or to spoof another client 105 by using its client ID. Also, it is possible for a client's ID to change if the client 105 is instructed to reconnect to a different node. This process all happens behind the scenes and the application layer will generally have no awareness of it.

In order to keep the load balanced across the location manager 170, a client 105 may be instructed to connect to a different node. This will usually happen right after the initial new client registration, but can happen at any time. The protocol will cause a reconnection message to be sent to the client 105. The message contains the IP address of the new server and a random string. The client 105 must close the existing TCP connection and open a new connection to the specified IP address. The message body contains the previously assigned client ID and the random string it received in the client reconnect message from the server. These messages are preferably scrambled to prevent them from being viewed and intercepted by someone with a network analyzer. The purpose of the random string in this exchange is to make sure that the client 105 that makes the new connection really is the same client 105 that was redirected. Once the server verifies that the random string matches what it expected, it will assign the client 105 a new client ID. If the client 105 had a previously registered client name, the protocol will automatically update the name-mapping database with the new client ID.

In the preferred embodiment, messages are addressed to client IDs rather than client names, so a means for mapping names into IDs is provided. A name resolution facility accomplishes this. A client 105 sends a message to the protocol (destination 0) with the message body containing a name resolution request. The protocol responds with a message directly to the client 105 (i.e., the DESTINATION field has the client's ID) where the message body contains the client ID associated with the client name.

It should be noted that in many cases there would be no need to deal with name resolution. Clients 105 such as jukeboxes 130 and mobile devices 160 will use name resolution to get the ID for the jukebox server 170B in the location manager 170, but in general, the existing jukebox server will not need to do a name look up in the other direction to map a jukebox's client name to an ID. The jukebox server will still be primarily a request/response server and the jukebox will know the client ID of the sender of a request and it will be able to send a message using that client ID rather than looking up the client's name.

Each message contains a single destination address, but there are situations where such a limited addressing scheme is not sufficient. Groups provide a mechanism for messages to be delivered to more than one client 105. There are two different types of groups: broadcast and balanced. In a broadcast group a message addressed to the group is delivered to every group member. In a balanced group, a message addressed to the group is delivered to only one group member, but each subsequent message is delivered to a different group member.

One use for broadcast groups is to associate an electronic device 105 with a location or venue. In this case, a message could be sent to all of the electronic devices 105 in the location, such as jukeboxes 130, and any mobile devices 160 that have checked in at the location.

Joining a group is accomplished via client registration. The data passed to the “register client” message must contain a client name and the type of group to be associated with the name. The first client 105 to register with that name determines the type of the group (broadcast or balanced). Any subsequent client registration that uses that name but specifies either a different group type or a non-group registration will fail and receive an error. Subsequent client registration with the same name and group type will become new group members. A given application can have multiple client registrations with any mixture of single client endpoints and groups. A client 105 leaves a group by deregistering the client 105. A group goes away when the last group member deregisters.

A client 105 sends a message using the API by specifying the recipient address either as a client name or ID, passing along any message flags and the body of the message to send. Messages to the protocol server are always UTF-8 encoded strings. The protocol server treats the message body for all messes not addressed to itself (DESTINATION not 0) as an opaque sequence of bytes and does not look at the data or interpret it in any way.

When a protocol server receives a message, it determines if the destination client 105 is also connected to that same server or to a different server. The high order byte of each client ID represents the server ID that owns the client connection. If the destination client 105 is connected to the local server, the message is sent directly to the indicated destination. If the destination client 105 is connected to a different server the current server forwards the message to the server that has the recipient.

Messages are preferably ‘fire and forget’ and the sender does not block when sending messages. There is no direct feedback that the message was successfully delivered. The API does provide a means for clients 105 to be informed of delivery failures. At the wire level, if a message cannot be delivered, it will be returned to the client 105 with the appropriate flags set to indicate the error. The API provides a callback interface that the client 105 can use to retrieve the errors.

In order to provide a resilient middleware layer and provide for horizontal scalability, the protocol server will be composed of a cluster of several computers (nodes) each running a copy of the protocol server. A client 105 will only connect to one of these nodes and the node cluster will handle routing messages between themselves in order to deliver messages between clients 105 connected to different nodes in the cluster. The nodes will communicate using UDP multicast so they must reside within a single broadcast domain.

There are two approaches to handling name resolution in the node cluster: each node could keep a full copy of the name/client mapping or the mapping could be distributed across the nodes with each node being authoritative for the clients 105 connected to it and other nodes querying the cluster for unknown names and keeping their own local cache for mappings they need.

Another approach is to have each node track the names registered for its local connections and then make this data available by request to other nodes. If a node receives a name resolution request it will first look in its cache to see if it already knows the client ID mapping for that name. If it does not find the mapping in its cache it will send a multicast message to all other nodes. These nodes will search their name maps and respond to the requestor with the requested name's client ID. The requester will then answer the name resolution request and also store the mapping in a local cache.

When a client 105 with registered names disconnects the node it is connected to will send a multicast message to the other nodes indicating that the names are no longer valid. All nodes will remove those mappings from their cache. Nodes will also monitor the status of the other nodes in the cluster. When a node is discovered to have gone down it will remove all mappings for that node. The implementation of the name mapping may local memory storage in a hash map or an external database.

To keep the connection load balanced across the node cluster it may be necessary to redirect a currently connected client 105 to a different node. This will generally happen immediately after a client 105 connects, but it can happen at any time. The cluster nodes will monitor the connection load on each other and a node can decide that it wants to move one of its connections to a different node.

This process is initiated by the node that wants to move a connection sending a message over the UDP multicast connection to the other server. This message will essentially ask the other server for permission to make the handoff. If the other accepts the handoff, it will send back a message indicating it will accept the client 105 connection. This message will contain a code string that the originating node will send to the client 105 when it sends the reconnect message. The client 105 will include this code string when it connects to the new node. This code string ensures to the new node that the client 105 that is connecting really is the client 105 that it is expecting. All of these handoff messages must be encrypted using a scrambler index to prevent a malicious third party from hijacking the client handoff.

The original node will keep a record of the clients 105 it has handed off for some period of time. If a message arrives addressed to one of these clients 105 it will automatically forward the message to the correct node and send a control message to the sender informing it of the new client's new ID. If a message arrives after the original server has discarded the forwarding information the message sender will receive an error about the unknown client 105. It may then perform another name resolution attempt to try to find the client.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A venue-specific entertainment system comprising:
a communications controller configured to communicate with a plurality of electronic devices deployed at a venue; and
a plurality of electronic devices deployed at the venue, the plurality of electronic devices configured to communicate with one another by transmitting messages to, and receiving messages from, the communications controller;
wherein the plurality of electronic devices includes at least two different types of electronic devices; and
wherein the communications controller is configured to receive information from a first electronic device of the plurality of electronic devices regarding a function performed by the first electronic device and, based upon the received information from the first electronic device, transmit a message to a second electronic device of the plurality of electronic devices to cause the second electronic device to modify an output.

2. The venue-specific entertainment system of claim 1, wherein the at least two different types of electronic devices are selected from televisions, currency-operated amusement devices, jukeboxes, and mobile computing devices.

3. The venue-specific entertainment system of claim 1, wherein the plurality of electronic devices includes at least three different types of electronic devices.

4. The venue-specific entertainment system of claim 1, wherein the communications controller is further configured to receive information from a third electronic device of the plurality of electronic devices regarding a function performed by the third electronic device and, wherein the transmitting of a message to a second electronic device is further based upon the received information from the third electronic device.

5. The venue-specific entertainment system of claim 1, wherein the communications controller is further configured to identify one or more events indicated by the information received from the first electronics device and identify one or more actions to be performed by the second electronics device in response to the identified one or more events.

6. The venue-specific entertainment system of claim 1, wherein information from a first electronic device of the plurality of electronic devices regarding a function performed by the first electronic device is one of information regarding a scoring play in a sporting event, a timeout in a sporting event, and a commercial during a sporting event.

7. The venue-specific entertainment system of claim 1, wherein information from a first electronic device of the plurality of electronic devices regarding a function performed by the first electronic device is information regarding a song dedication and the message transmitted to the second electronic device comprises information to cause the second electronic device to display information derived from the information regarding a song dedication.

8. The venue-specific entertainment system of claim 1, wherein the communications controller is further configured to transmit a message to a third electronic device, wherein the message transmitted to the third electronic device comprises information to cause the third electronic device to play a song as the second device displays information derived from the information regarding a song dedication.

9. The venue-specific entertainment system of claim 1, wherein the information from a first electronic device of the plurality of electronic devices regarding a function performed by the first electronic device comprises information regarding a game being played using the first electronic device, and the message transmitted to a second electronic device of the plurality of electronic devices to cause the second electronic device to modify an output comprises information to be displayed by the second electronic device regarding the game.

10. The venue-specific entertainment system of claim 9, wherein the information to be displayed by the second electronic device regarding the game comprises score information or player identifier information.

11. A method of operating a venue-specific amusement device network, the amusement device network including a plurality of electronic devices, the plurality of electronic devices including devices of at least two types, the method comprising:
receiving information from a first electronic device of the plurality of electronic devices regarding presentation of content at the first electronic device;
identifying an event associated with the content being presented by the first electronic device; and
transmitting a notification regarding the identified event to at least one second electronic device of the plurality of electronic devices, wherein at least one of the second electronic devices is of a different type from the first electronic device;
wherein the notification is configured to cause the second electronic device to modify an output of the second electronic device based on the transmitted notification, wherein the output is modified based on the identified event.

12. The method of claim 11, wherein the second electronic device is a television.

13. The method of claim 11, wherein the at least one electronic device of another type is selected from the group consisting of a digital jukebox, a currency-operated amusement device, a mobile phone and a tablet computing device.

14. The method of claim 11, wherein the first electronic device is a currency-operated amusement device, the second electronic device is a television, and wherein the modifying an output of the second electronic device further comprises outputting a representation of game play from the currency-operated amusement device to the television.

15. The method of claim 11, wherein the first electronic device is a television and the identified event is selected from the group consisting of: a scoring play in a sporting event, a timeout in a sporting event, and a commercial during a sporting event.

16. The method of claim 11, wherein the second electronic device is a jukebox, and wherein modifying the output of the second electronic device further comprises outputting a sound effect or song based on the identified event.

17. The method of claim 11, wherein information from a first electronic device of the plurality of electronic devices regarding presentation of content at the first device is information regarding a song dedication, and the notification transmitted to the second electronic device comprises information to cause the second electronic device to display information derived from the information regarding a song dedication.

18. The method of claim 11, further comprising:
transmitting a notification to a third electronic device, wherein the notification transmitted to the third electronic device comprises information to cause the third electronic device to play a song as the second device displays information derived from the information regarding a song dedication.
